(19) United States
(12) Patent Application Publication
(10) Pub. No.: US 2006/0132273 A1
(43) Pub. Date: Jun. 22, 2006

(54) Inverter trasformer

(76) Inventors: Hiroshi Shinmen, Fukuroi-shi (JP); Masashi Norizuki, Fukuroi-shi (JP)

Correspondence Address: OLIFF & BERRIDGE, PLC, P.O. BOX 19928, ALEXANDRIA, VA, 22320, US

(21) Appl. No.: 10/560,090

(22) PCT Filed: Jun. 3, 2004
(86) PCT No.: PCT/JP04/07714

§ 371 Date: Dec. 9, 2005

(30) Foreign Application Priority Data
Jun. 9, 2003 (JP) 2003164174

(51) Int. Cl. H01F 5/00

(52) U.S. Cl. 336/200

(57) ABSTRACT

In an inverter transformer, a primary winding and a secondary winding are wound around each of two bar-shaped magnetic cores, and a magnetic resin covers all or some portions, including at least both end portion of the circumference, of the bar-shaped magnetic cores so that the primary and the secondary windings have respective predetermined leakage inductances. The magnetic resin has a substantially smaller relative magnetic permeability than the bar-shaped magnetic cores. Part of magnetic flux generated at the bar-shaped magnetic cores leaks out beyond the bar-shaped magnetic cores and further beyond the magnetic resin so as to provide leakage inductance, which functions as ballast inductance. Also, the amount of magnetic flux passing through the magnetic resin and leaking out beyond the magnetic resin is reduced, and influence to the area around the inverter transformer is reduced.

### BACKGROUND OF THE INVENTION

1. Field of the Invention

The present invention relates to an inverter transformer for use in an inverter circuit to light a discharge lamp, such as a cold cathode fluorescent lamp, as a light source of a lighting device for a liquid crystal display.

2. Description of the Related Art

Currently, a liquid crystal display (LCD) is increasingly used as a display unit for a personal computer, and the like. The LCD lacks a light emitting function, and therefore requires a lighting device, such as a back-light system or a front-light system, and a cold cathode fluorescent lamp (CCFL) is generally used as a light source for such a lighting device. In case of discharging and lighting a CCFL having a length, for example, about 500 mm, an inverter circuit is used which is adapted to generate a high-frequency voltage of 60 kHz, about 1600 V at the time of starting discharge. The inverter circuit controls a voltage applied to the CCFL such that after the CCFL is discharged, the voltage is lowered to about 1200 V which is a voltage required for keeping the discharge. Some inverter circuits include a closed magnetic path type inverter transformer and also a ballast capacitor, and the ballast capacitor additionally required prohibits reduction in dimension and cost. Further, even after discharging a CCFL, the voltage at the time of starting discharge must be maintained, which is disadvantageous in view of safety.

Recently, an open magnetic path type inverter transformer is employed which leverages the function of a leakage inductance serving as a ballast capacitance in place of a ballast capacitor. Some of such open magnetic path type inverter transformers may use a bar-shaped magnetic core (I-core), and others may use a combination of a bar-shaped magnetic core and a rectangular frame-shaped magnetic core (refer to Japanese Patent Application Laid-Open No. 2002-353044).

FIG. 16 is an equivalent circuit of an inverter transformer having a leakage inductance as described above. Referring to FIG. 16, the inverter transformer includes an ideal transformer 1 having no loss with a winding ratio of 1:n, leakage inductances L1 and L2, and a mutual inductance Ls, and CCFLs 2. In the inverter transformer, the leakage inductances L1 and L2 function as a ballast inductance, and the CCFLs 2 can be lighted normally without using a ballast capacitor.

FIG. 17 is a schematic view of a conventional inverter transformers of open magnetic path type. The inverter transformer 1 includes a bar-shaped magnetic core (I-core) 3 indicated by a dashed line, a bobbin 4 defining a hollow 5 to house the bar-shaped magnetic core 3, a primary winding 6 wound around the bobbin 4, a secondary winding 7 wound around the bobbin 4, a terminal block 9 provided with terminal pins 8 for the primary winding 6, and a terminal block 11 provided with terminal pins 10 for the secondary winding 7. Since a high voltage is induced at the secondary side, the secondary winding 7 is divided by partitions 12 formed at the bobbin 4 in order to prevent surface discharge. The inverter transformer 1 in FIG. 17, which employs a bar-shaped magnetic core as described above, is simple in structure compared with an inverter transformer (not shown) which employs a magnetic core having a closed configuration, such as a rectangular core. However, magnetic flux leaks from the bar-shaped magnetic core, especially from the ends thereof

FIG. 18 is an exploded perspective view of another conventional inverter transformer 1A. The inverter transformer 1A includes a bar-shaped magnetic core 3, a rectangular frame-shaped magnetic core 13, a bobbin 14 having a hollow to house the bar-shaped core 3, and primary and secondary windings 6 and 7 wound around the bobbin 14. The end portions of the bar-shaped magnetic core 3 are engaged with respective recesses 15 of the rectangular frame-shaped magnetic core 13 such that gap sheets formed of a non-magnetic material are put between the bar-shaped magnetic core 3 and the rectangular frame-shaped magnetic core 13 so as to form gaps therebetween, thereby generating a prescribed amount of leakage inductance. In the inverter transformer 1A thus structured, magnetic flux leaking from the bar-shaped core 3 passes through the rectangular frame-shaped magnetic core 13, and leakage flux is small compared with the inverter transformer 1 shown in FIG. 17.

In an inverter transformer involving leakage inductance, leakage flux may possibly influence neighboring components or wires, or emit noises, and the components and wires must be appropriately located in order to keep away from the leakage flux thus placing restrictions on arrangement of components and wires. This may result in increase of product dimension or deterioration of characteristics. Also, if a magnetic material is placed at the path of the leakage flux, the flux path may be influenced when the leakage flux passes through the magnetic material, which causes the leakage inductance to vary or fluctuate disturbing stability, further causing the inverter transformer to undergo variation in characteristic and consequently to undergo change in operation.

Thus, an inverter transformer including only a bar-shaped magnetic core is simple in structure but suffers increase in leakage flux distribution range, and also has difficulty in adjusting the amount of leakage inductance. On the other hand, an inverter transformer including a rectangular frame-shaped magnetic core together with a bar-shaped magnetic core has a smaller leakage flux distribution range than the inverter transformer including a bar-shaped magnetic core only, but incurs increase in number of components, and a molding or machining process is required for producing the rectangular frame-shaped magnetic core. Also, when engaging the bar-shaped magnetic core with the rectangular frame-shaped magnetic core, a complex and troublesome process of putting gap sheets therebetween is required for adjusting leakage inductance.

An inverter transformer incorporating only a bar-shaped magnetic core generates a wide distribution range of leakage flux as described above. Such an inverter transformer is magnetically shielded in order to prevent the inverter transformer from affecting neighboring components, and also to prevent the neighboring components from affecting the inverter transformer. This solution by magnetically shielding a product, however, requires a shielding case, and this leads to increase in product dimension and product cost. Also, processes of fixing the inverter transformer to the shielding case and taking out lead wires from the shielding case are additionally required, thus making cost reduction further difficult. And, a defective fixing of the inverter transformer to the shielding case may raise deterioration in reliability. On the other hand, an inverter transformer employing a rectangular frame-shaped magnetic core together with a rectangular frame-shaped magnetic core, while generating a reduced amount of leakage flux, has a complicated structure and requires additional troublesome manufacturing processes thus pushing up production cost.

### SUMMARY OF THE INVENTION

The present invention has been made in the light of the above problems, and it is an object of the present invention to provide an inverter transformer which has an open magnetic path structure but is simple in structure, and which has its production process simplified compared with a conventional open magnetic path structure including a rectangular frame-shaped magnetic core, thus preventing cost increase.

In order to achieve the object described above, according to an aspect of the present invention, there is provided an inverter transformer, which is used in an inverter circuit to invert DC into AC, transforms a voltage inputted at the primary side and outputs the transformed voltage at the secondary side, and which includes at least one winding unit including: a bar-shaped magnetic core; and a primary winding and a secondary winding wound around the bar-shaped magnetic core. In the inverter transformer described above, at least one portion of the winding unit with respect to the core length direction is covered by a magnetic resin formed of a resin containing a magnetic substance so that the primary and the secondary windings have respective predetermined leakage inductances.

In the aspect of the present invention, the magnetic resin may cover the entire portion of the winding unit with respect to the core length direction.

In the aspect of the present invention, the magnetic resin may cover, with respect to the core length direction, both end portions of the winding unit, and/or a portion of the winding unit located at a boundary area between the primary and secondary windings.

In the aspect of the present invention, an external unit having a larger saturation magnetic flux density than the magnetic resin may be disposed so as to cover at least one portion of a circumference of a transformer body which comprises the at least one winding unit and the magnetic resin.

In the aspect of the present invention, the external unit may have a smaller magnetic resistance than the magnetic resin.

In the aspect of the present invention, the external unit may have either a squared C configuration or a substantially circular configuration in cross section so as to cover the circumference of the transformer body.

In the aspect of the present invention, the external unit may comprise a plurality of members, and the members are combined into a box configuration so as to cover the transformer body.

In the aspect of the present invention, the external unit may be made of a sintered material.

In the aspect of the present invention, the magnetic resin my have a smaller relative magnetic permeability than the bar-shaped magnetic core.

In the aspect of the present invention, the magnetic substance contained in the resin may be either Mn—Zn ferrite, Ni—Zn ferrite, or iron powder.

Since the magnetic resin formed of a resin containing a magnetic substance is disposed so as to cover at least one portion of the winding unit so that the primary and the secondary windings have respective predetermined leakage inductances, the amount of leakage flux spreading around the inverter transformer is reduced compared with when the winding unit is not covered by the magnetic resin, which results in having a reduced influence on the components and wires arranged around the inverter transformer. This structure also contributes to making it harder for the characteristics of the inverter transformer to suffer the effects of metals present around the inverter transformer. When the winding unit is totally covered by the magnetic resin, a case for shielding is not required, which prevents cost increase, and which eliminates the need of fixing the inverter transformer inside the case and taking out lead wires from the case thus easing the manufacturing process. This total coverage by the magnetic resin increases mechanical strength of the inverter transformer thus enhancing product reliability.

Also, the number of turns and the leakage inductance on the winding can be adjusted to the optimum conditions of the circuit operation by adjusting the magnetic characteristics such as relative magnetic permeability of the magnetic resin and adjusting the coverage area and thickness of the magnetic resin. Consequently, the inductance value can be adjusted without changing the number of turns on the primary and secondary windings and the configuration and characteristics of the bar-shaped magnetic core, thus providing applicability to various inverter transformers.

And, since the external unit having a larger saturation magnetic flux density than the magnetic resin is disposed so as to cover at least one portion of the circumference of the transformer body including the at least one winding unit and the magnetic resin, most of the magnetic flux leaking out from the bar-shaped magnetic core so as to pass through the magnetic resin and then to leak out further from the magnetic resin is adapted to pass through the external unit. Consequently, the amount of the leakage flux can be reduced effectively compared when the magnetic flux is prevented from leaking out by the magnetic resin only without providing the external unit, and therefore the thickness of the magnetic resin can be reduced, which results in reduction of the entire cross section area of the inverter transformer thus downsizing the inverter transformer.

### BRIEF DESCRIPTION OF THE DRAWINGS

FIGS. 1(a) and 1(b) are respectively schematic top plan and front elevation views of an inverter transformer according to a first embodiment of the present invention;

FIGS. 1(c) and 1(d) are respectively front elevation and partial cross-sectional views of an inverter transformer according to a second embodiment of the present invention;

FIGS. 2(a) and 2(b) are respectively schematic perspective and partial cross-sectional views of the inverter transformer according to the aforementioned first embodiment;

FIG. 3 is an explanatory view of position for measuring a magnetic field on inventive and comparative samples;

FIG. 4 is a graph showing measurement results on the inventive and comparative samples;

FIGS. 5(a) and 5(b) are respectively schematic top plan and front elevation views of an inverter transformer according to a third embodiment of the present invention;

FIG. 5(c) is an elevation view of an inverter transformer according to a fourth embodiment of the present invention;

FIGS. 6(a), 6(b) and 6(c) are respectively schematic top plan, cross-sectional (taken along line X-Y in FIG. 6(a)), and front elevation views of an inverter transformer according to a fifth embodiment of the present invention, and FIG. 6(d) is a perspective view of an external unit used in the inverter transformer of FIGS. 6(a), 6(b) and 6(c);

FIGS. 7(a) and 7(c) are respectively schematic top plan and front elevation views of an inverter transformer according to a sixth embodiment of the present invention, and FIG. 7(b) is a perspective view of an external unit used in the inverter transformer of FIGS. 7(a) and 7(c);

FIGS. 8(a) and 8(c) are respectively schematic top plan and front elevation views of an inverter transformer according to a seventh embodiment of the present invention, FIG. 8(b) is a perspective view of an external unit used in the inverter transformer of FIGS. 8(a) and 8(c), and FIG. 8(d) is a front elevation view of another inverter transformer according to the seventh embodiment including a different type transformer body;

FIGS. 9(a) and 9(b) are respectively schematic top plan and cross-sectional (taken along line X-Y in FIG. 9(a)) views of an inverter transformer according to an eighth embodiment of the present invention, FIG. 9(c) is a perspective view of an external unit used in the inverter transformer of FIGS. 9(a) and 9(b), and FIG. 9(d) is a perspective view of an external unit used in an inverter transformer according to a ninth embodiment of the present invention;

FIGS. 10(a) and 10(b) are respectively schematic top plan and front elevation views of an inverter transformer according to a tenth embodiment of the present invention;

FIGS. 11(a) and 11(b) are respectively schematic top plan and front elevation views of an inverter transformer according to an eleventh embodiment of the present invention, and FIG. 11(c) is a front elevation view of another inverter transformer according to the eleventh embodiment including a different type transformer body;

FIGS. 12(a) and 12(b) are respectively schematic top plan and front elevation views of an inverter transformer according to a twelfth embodiment of the present invention, and FIG. 12(c) is a front elevation view of an inverter transformer according to a thirteenth embodiment of the present invention;

FIGS. 13(a) and 13(c) are respectively schematic top plan and cross-sectional views of an inverter transformer according to a fourteenth embodiment of the present invention, FIG. 13(b) is a perspective view of an external unit used in the inverter transformer of FIGS. 13(a) and 13(c), and FIG. 13(d) is a cross-sectional view of an inverter transformer according to a fifteenth embodiment of the present invention;

FIGS. 14(a) and 14(b) are respectively schematic top plan and front elevation views of an inverter transformer according to a sixteenth embodiment of the present invention, FIG. 14(c) is a front elevation view of an inverter transformer according to a seventh embodiment of the present invention, and FIG. 14(d) is a perspective view of an external unit used in the inverter transformer of FIGS. 14(a) and 14(b) and the inverter transformer of FIG. 14(c);

FIGS. 15(a) and 15(b) are respectively schematic top plan and cross-sectional views of an inverter transformer according to an eighteenth embodiment of the present invention, and FIG. 15(c) is a cross-sectional view of an inverter transformer according to a nineteenth embodiment of the present invention;

FIG. 16 is an equivalent circuit of an inverter transformer having a leakage inductance;

FIG. 17 is a schematic to plan view of a conventional inverter transformer including a bar-shaped magnetic core; and

FIG. 18 is an exploded perspective view of another conventional inverter transformer including a bar-shaped magnetic core.

### DETAILED DESCRIPTION OF THE PREFERRED EMBODIMENTS

Preferred embodiments of the present invention will hereinafter be described with the accompanying drawings, in which like reference numerals refer to like components.

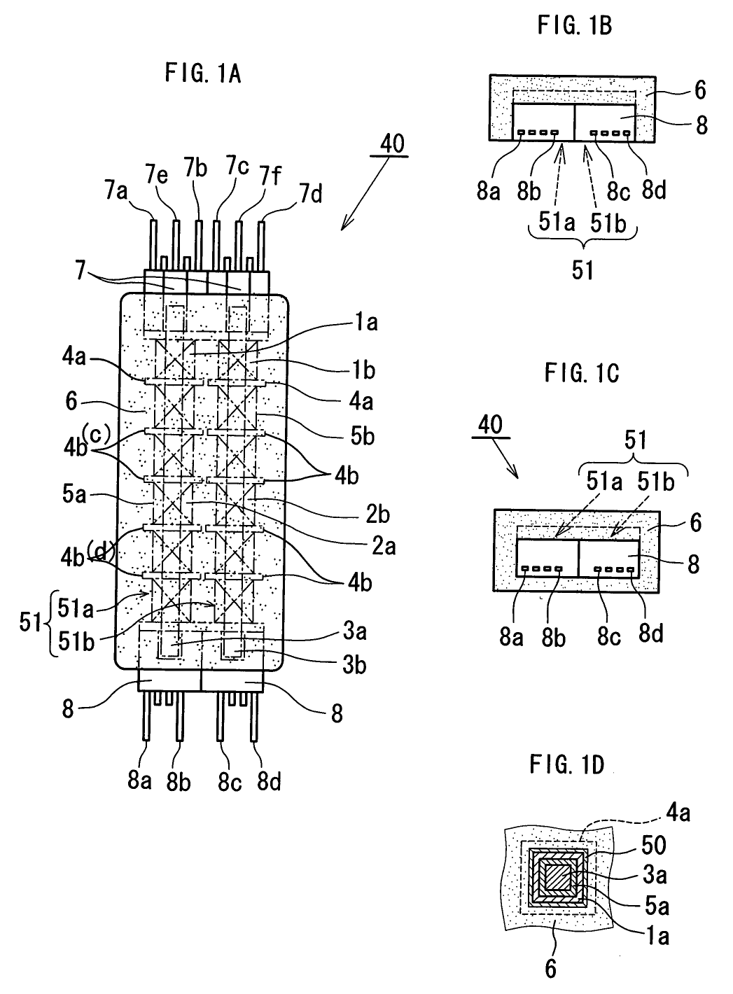

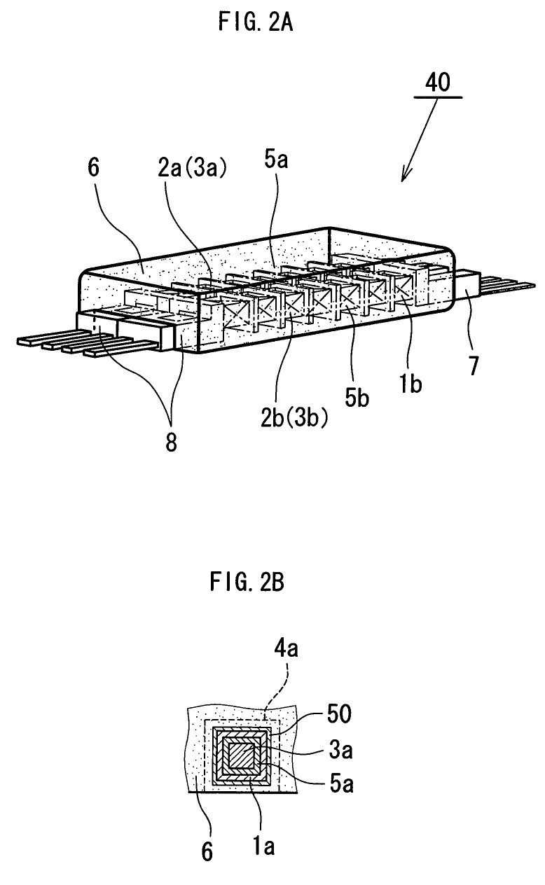

A first embodiment of the present invention will be described with FIGS. 1(a) and 1(b), and FIGS. 2(a) and 2(b). An inverter transformer 40 according to the first embodiment is for lighting two CCFLs concurrently.

Referring to Fig. 1(a), the inverter transformer 40 is of an open magnetic path structure and generally includes: two bar-shaped magnetic cores (hereinafter referred to simply as “cores” as appropriate) 3a and 3; two primary windings 1a and 1b; two secondary windings 2a and 2b; two rectangular tubular bobbins (hereinafter referred to simply as “bobbins” as appropriate) 5a and 5b; a magnetic resin 6 made of resin containing a magnetic substance and adapted to cover the aforementioned components; and terminal blocks 7 and 8 formed of an insulating material and disposed separately at the ends of the bobbins 5a and 5b so as to sandwich the bobbins 5a and 5b. In the structure described above, an insulation resin 50 is disposed between the primary/secondary winding 1a/2a and the magnetic resin 6 as shown in FIG. 2(b), and, though not shown, another insulation resin 50 is disposed between the primary/secondary winding 1b/2b and the magnetic resin 6. The number of bar-shaped magnetic cores is not limited to two but may be, for example, three for lighting three CCFLs, or alternatively may be one for lighting a plurality of CCFLs. The terminal block 7 has terminal pins 7a to 7f implanted thereat, and the terminal block 8 has terminal pins 8a to 8d implanted thereat.

Referring to FIGS. 1(a), 2(a) and 2(b), the cores 3a and 3b are inserted through the bobbins 5a and 5b, respectively, which are engagingly put together. The cores 3a and 3b are formed of a soft magnetic material, such as Mn—Zn ferrite, and have a relative magnetic permeability of, for example, about 2000. The primary and secondary windings 1a and 2a are wound around the bobbin 5a and adapted to light one of the two CCFLs, and the primary and secondary windings 1b and 2b are wound around the bobbin 5b and adapted to light the other one of the two CCFLs. The bobbin 5a/5b includes a partition 4a to separate the primary winding 1a/1b and the secondary winding 2a/2b. Thus, the primary winding 1a/1b is located between the terminal block 7 and the partition 4a, and the secondary winding 2a/2b is located between the terminal block 8 and the partition 4a. The bobbin 5a/5b further includes a plurality (four in the figure) of insulating partitions 4b to split the secondary winding 2a/2b into several sections with respect to the length direction, because a high voltage is generated at the secondary winding 2a/2b. The insulating partitions 4b function to increase the surface distance between each of the several sections of the secondary windings 2a/2b in order to prevent surface discharge. The starting and finishing ends of the primary windings 1a and 1b are connected to the terminal pins 7a to 7d. The starting and finishing ends of the secondary winding 2a are connected to the terminal pins 7e and 8a (or 8b), and the starting and finishing ends of the secondary winding 2b are connected to the terminal pins 7f and 8c (or 8d).

The core 3a, the bobbin 5a, the primary winding 1a, the secondary winding 2a, and the insulation resin 50 applied so as to cover the aforementioned members constitute a first winding unit 51a, and the core 3b, the bobbin 5b, the primary winding 1b, the secondary winding 2b, and the other insulation resin 50 applied so as to cover the aforementioned members constitute a second winding unit 51b. The first and second winding units 51a and 51b thus constituted make up a winding assembly 51. The winding assembly 51 is covered by the magnetic resin 6 except the bottom face as shown by FIG. 1(b), wherein the magnetic sold resin 6 covers the cores 3a and 3b longitudinally from their one ends all the way to the other ends, and further covers parts of the terminal blocks 7 and 8.

The magnetic resin 6 is formed of a mixture produced by mixing a magnetic substance of powder gained by pulverizing sintered Mn—Zn ferrite, and, for example, a thermosetting epoxy resin, where the Mn—Zn ferrite powder accounts for 80% in terms of volume ratio. The mixture thus produced is applied to the winding assembly 51 (the first and second winding units 51a and 51b constituted as described above) by molding, spreading, or the like, and is heated and cured by a temperature of, for example, 150 degrees C., whereby the mixture applied turns into the magnetic resin 6. The magnetic substance for the magnetic resin 6 is not limited to Mn—Zn ferrite, but may be Ni—Zn ferrite or ion powder, and the resin material may alternatively be nylon, and the like, which achieves a similar effect. The relative magnetic permeability of the magnetic resin 6 is determined so as to effectively shield against leakage flux coming out from the cores 3a and 3b and at the same time to duly constitute an open magnetic path structure. The relative magnetic permeability can of the magnetic resin 6 be controlled by changing the property of the magnetic substance, or changing the mixing ratio of the magnetic substance to the resin. For example, Mn—Zn ferrite or Ni—Zn ferrite achieves a relative magnetic permeability of several tens, and iron power achieves a relative magnetic permeability of several hundreds.

In the inverter transformer 40 according to the first embodiment, the magnetic resin 6 is arranged so as to cover the top and side faces only of the winding assembly 51, but the present invention is not limited to this arrangement and the magnetic resin 6 may alternatively be arranged so as to cover, for example, the top face only, the side faces only, or the bottom face only of the winding assembly 51, or the whole circumference of the winding assembly 51 as described below.

Referring now to FIGS. 1(c) and 1(d), an inverter transformer 40 according to a second embodiment of the present invention is structured identically with the inverter transformer 40 according to the first embodiment except that a magnetic resin 6 is arranged so as to cover the entire circumference, namely, the top, side, and bottom faces of a winding assembly 51.

In the above-described inverter transformers 40 according to the first and second embodiments, the entire portions of the cores 3a and 3b and some portions of the terminal blocks 7 and 9 are covered with respect to the length direction by the magnetic resin 6. In the first and second embodiments described above, the cores 3a and 3b (the first and second winding units 51a and 51b) are covered together by the magnetic resin 6 of one piece structure, but the present invention is not limited to this structure and may alternatively be structured such that the cores 3a and 3b (the first and second winding units 51 and 51b) are covered individually by respective pieces of a magnetic resin structure composed of two separate pieces.

The operation of the inverter transformers 40 according to the first and second embodiments will hereinafter be described.

Since the magnetic resin 6 has a significantly smaller relative magnetic permeability than the cores 3a and 3b, all of magnetic fluxes generated at the cores 3a and 3b are not adapted to pass through the magnetic resin 6, but some parts of the magnetic fluxes are allowed to leak beyond the magnetic resin 6 due to the difference of their magnetic resistances, and thus leakage inductance is provided. That is to say, the magnetic path generated by the cores 3a and 3b and the magnetic resin 6 is not a closed magnetic path, and therefore the inverter transformer 40 substantially has an open magnetic path structure having leakage inductance. Accordingly, there is generated not only magnetic flux that passes entirely through the core 3a/3b so as to interlink the primary winding 1a/1b and the secondary winding 2a/2b, but also leakage flux that interlinks either with the primary winding 1a/1b only or with the secondary winding 2a/2b only thus failing to contribute to providing electromagnetic coupling between the primary winding 1a/1b and the secondary winding 2a/2b, whereby leakage inductance is generated. The inverter transformer 40 operates in the same way as an inverter transformer of an open magnetic path structure without the magnetic resin 6, and the aforementioned leakage inductance acts as ballast inductance so as to duly discharge and light the CCFLs connected to the secondary windings 2a and 2b.

While the leakage inductance acts as ballast inductance, the winding assembly 51 is covered by the magnetic resin 6, and therefore most of magnetic flux coming from the core 3a/3b is adapted to pass through the magnetic resin 6, reducing the amount of magnetic flux to leak beyond the magnetic resin 6. Consequently, the range of leakage flux spreading out from the inverter transformer 40 is limited.

The inverter transformer 40 according to the first embodiment, which does not have its bottom face covered by the magnetic resin 6, is desirable and suitable when mounted on a substrate or chassis made of a non-magnetic material. Specifically, when the inverter transformer 40 according to the first embodiment is mounted on a non-magnetic substrate or chassis, the magnetic path of the magnetic flux leaking from the core 3a/3b in the bottom direction is not influenced by anything thus reducing variation or change in the property. On the other hand, since the other faces than the bottom face, that is to say, the top and side faces, are covered by the magnetic resin 6, the range of leakage flux spreading out from the inverter transformer 40 is limited. Consequently, leakage inductance is duly achieved without having influence on the other components, and at the same time the height of the inverter transformer 40 can be reduced due to its bottom face not covered by the magnetic resin 6.

The inverter transformer 40 according to the second embodiment, which has its top, side, and bottom faces covered by the magnetic resin 6, is desirable and suitable when mounted on a substrate or chassis made of a magnetic material. Specifically, since the bottom face of the inverter transformer 40 according to the second embodiment is also covered by the magnetic resin 6, magnetic flux leaking from the core 3a/3b is not subject to the influence of the magnetic substrate or chassis disposed under the bottom face due to the magnetic shielding function of the magnetic resin 6, and therefore the magnetic path of the magnetic flux is not changed thus reducing variation in the property.

For optimizing the operation of an inverter transformer, the numbers of turns on primary and secondary windings and leakage inductance must be adjusted, but the characteristic of leakage inductance is caused to vary with a change in the magnetic property of the magnetic path of leakage flux. On the other hand, in the inverter transformer 40 of the present invention, leakage inductance is adjusted according to the optimal conditions for the circuit operation by adjusting the magnetic properties (such as relative permeability), thickness, and area range of the magnetic resin 6. As a result, the operation of the inverter transformer 40 can be flexibly optimized for application to various kinds of inverter transformers simply by adjusting the value of leakage inductance without changing the numbers of turns on the primary windings 1a and 1b and the secondary windings 2a and 2b and also the configuration and property of the cores 3a and 3b.

In the inverter transformers 40 according to the first and second embodiments, the magnetic resin 6 is disposed so as to cover the bar-shaped cores 3a and 3b entirely from one end to the other, but insofar as leakage inductance is duly provided, the magnetic resin 6 does not necessarily have to entirely cover the cores 3a and 3b and may alternatively be disposed so as to partly cover the cores 3a and 3b. Such a partial coverage structure is employed in third and fourth embodiments of the present invention described below.

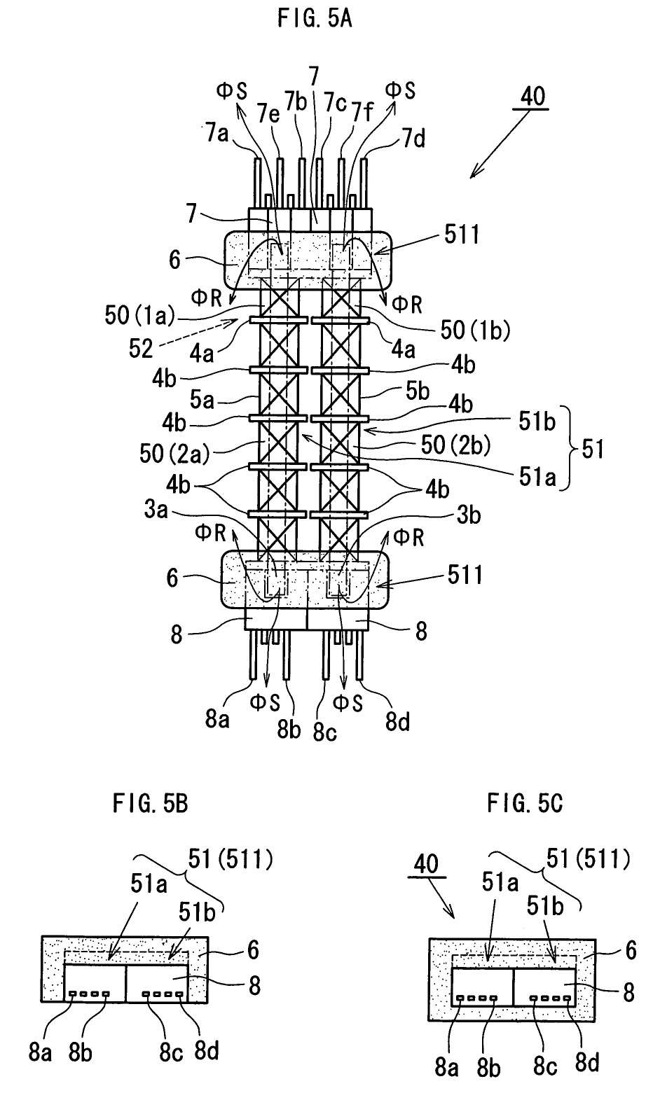

The third and fourth embodiments of the present invention will be described with reference to FIGS. 5(a), 5(b) and 5(c). In explaining the examples shown in FIGS. 5(a), 5(b) and 5(c), any component parts corresponding to those in FIGS. 1(a) to 1(d) and FIG. 2(a) and 2(b) are denoted by the same reference numerals, and a detailed description thereof will be omitted below.

Referring to FIGS. 5(a) and 5(b), in an inverter transformer 40 according to the third embodiment, one end portion 511 of a winding assembly 51 (including bar-shaped magnetic cores 3a and 3b), and a portion of a terminal block 7 are covered by one of two separate magnetic resins 6 at the top and side faces, and the other end portion 511 of the winding assembly 51, and a portion of a terminal block 8 are covered by the other one of the two separate magnetic resins 6 at the top and side faces, while the middle portion of the winding assembly 51 is totally exposed at all the faces. On the other hand, in an inverter transformer 40 according to the fourth embodiment, both end portions 511, 511 of a winding assembly 51, and respective portions of terminal blocks 7 and 8, are covered respectively by two separate magnetic resins 6, 6 at the top, side, and bottom faces as shown in FIG. 5(c) with the middle portion of the winding assembly 51 totally exposed at all the faces.

The inverter transformer 40 according to the third embodiment is similar to the inverter transformer 40 according to the first embodiment in that the magnetic resin 6 covers the top and side faces of the winding assembly 51 as shown in FIGS. 1(B) and 5(b), and the inverter transformer 40 according to the fourth embodiment is similar to the inverter transformer 40 according to the second embodiment in that the magnetic resin 6 covers the top, side, and bottom faces of the winding assembly 51 as shown in FIGS. 1(c) and 5(c). The inverter transformers 40 according to the third and fourth embodiments achieve an operational effect similar to that of the inverter transformer 40 according to the first embodiment.

In the inverter transformers 40 according to the third and fourth embodiments, since both end portions of the cores 3a and 3b (the winding assembly 51) are covered totally or partly by respective magnetic resins 6, 6, most of leakage flux (DR coming out from the end portion of the core 3a/3b is adapted to pass through the magnetic resin 6 functioning as a shield, and consequently the amount of leakage flux (DS spreading out in the open air around is reduced. Since the inverter transformers 40 according to the third and fourth embodiments are of an open magnetic path structure like the inverter transformer 40 according to the first embodiment, leakage inductance is generated at primary windings 1a and 1b and secondary windings 2a and 2b and functions as ballast inductance so as to duly light CCFLs.

In the third and fourth embodiments described above, the end portion of the core 3a (first winding unit 51a) and the end portion of the core 3b (second winding unit 51b) are covered together by the one piece magnetic resin 6, but the present invention is not limited to this structure and may alternatively be structured such that the end portion of the core 3a and the end portion of the core 3b are covered individually by two separate magnetic resins, respectively. In the inverter transformers 40 according to the third and fourth embodiments, leakage inductance is adjusted according to the optimal conditions for the circuit operation by adjusting the magnetic properties (such as relative permeability), thickness, and area range of the magnetic resin 6.

In the third and fourth embodiments, since the leakage flux (DS coming from the end portion of the core 3a/3b and spreading out in the open air around is reduced as described above, components arranged close to the end portions of the cores 3a and 3b are kept magnetically uninfluenced, and at the same time, the inverter transformer 40 is prevented from getting influenced by magnetic flux coming from the components thus reducing variation and change in characteristics. Also, influences can be eliminated that may possibly arise when components including a magnetic substance are arranged close to the end portions of the cores 3a and 3b.

Also, in the third and fourth embodiments, a partition portion 52 of the winding assembly 51 (composed of the first winding unit 51a and the second winding unit 51b) provided with partitions 4a to separate the primary windings la/1b from the secondary windings 2a/2b may be covered by an additional magnetic resin. The partition portion 52 is an area where leakage flux is generated abundantly, and covering the partition portion 52 by a magnetic resin is very effective in further reducing the amount of magnetic flux exiting out from the inverter transformer 40 in the open space around. This measure of covering the partition portion 52 by a magnetic resin may be effectively implemented not only in the inverter transformer 20 according to the fourth or fifth embodiment but also in a conventional inverter transformer.

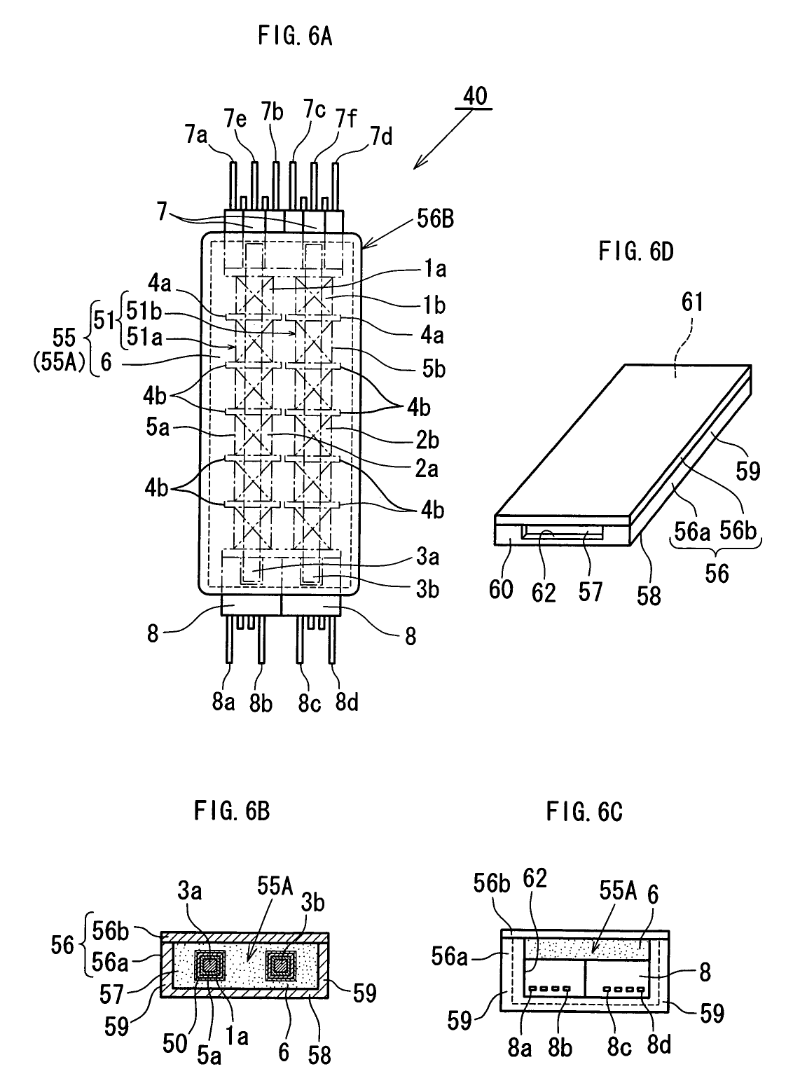

A fifth embodiment of the present invention will be described with reference to FIGS. 6(a) to 6(d). In explaining the example shown in FIGS. 6(a) to 6(d), any component parts corresponding to those in FIGS. 1(a) to 1(d) and FIGS. 2(a) and 2(b) are denoted by the same reference numerals, and a detailed description thereof will be omitted below.

Referring to FIG. 6(a), an inverter transformer 40 according to the fifth embodiment includes a winding assembly 51 which includes cores 3a and 3b, bobbins 5a and 5b, primary windings 1a and 1b, secondary windings 2a and 2b, and insulation resins 50, and a magnetic resin 6 which covers the aforementioned winding assembly 51 at all the faces, specifically, the top, side, and bottom faces (that is to say, the winding assembly 51 and the magnetic resin 6 are structured substantially identical with those of the inverter transformer 40 according to the second embodiment), wherein the winding assembly 51 and the magnetic resin 6 constitute a transformer body 55.

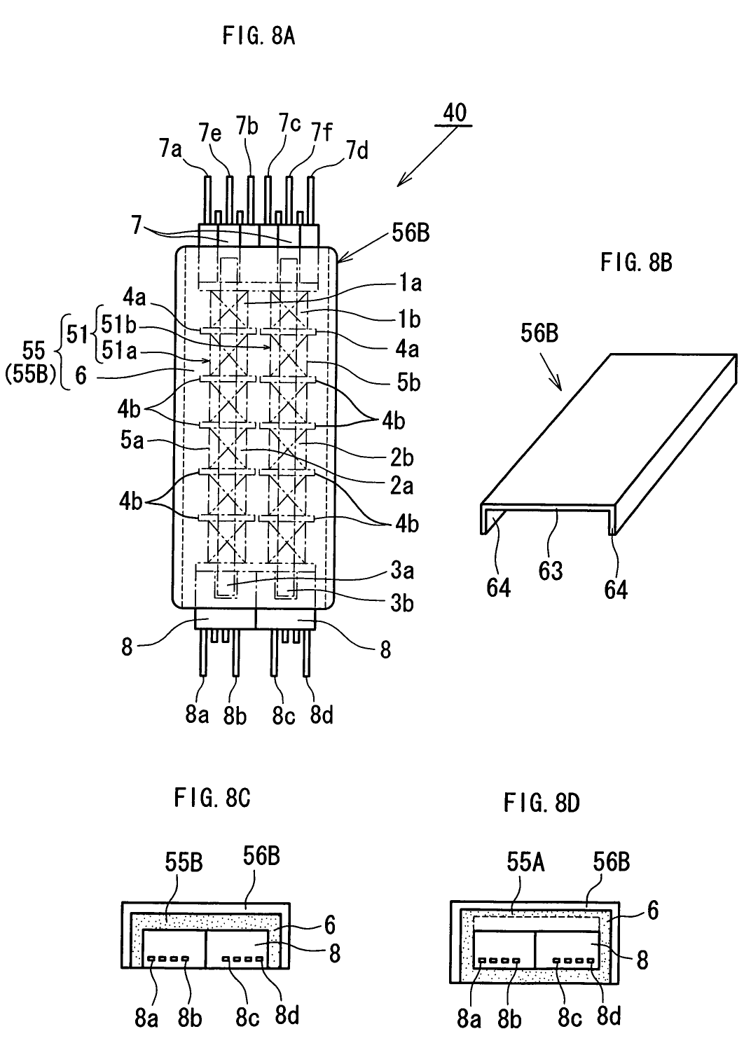

For the sake of convenience, the transformer body 55 will be grouped into two types: one type is a transformer body 55A, in which a winding assembly is covered by a magnetic resin at the top, side, and bottom faces as shown in FIGS. 6(b) and 6(c); and the other type is a transformer body 55B, in which a winding assembly is covered by a magnetic resin at the top and side faces (refer to FIGS. 8(a) and 8(c)).

Referring to FIGS. 6(a) to 6(c), in the inverter transformer 40 according to the fifth embodiment, the transformer body 55A is enclosed by an external unit 56 with terminal blocks 7 and 8 sticking out. The external unit 56 is composed of sintered compacts formed of, for example, Mn—Zn ferrite, or Ni—Zn ferrite, and has a larger saturation magnetic flux density and a smaller magnetic resistance than the magnetic resin 6. Referring to FIG. 6(d), the external unit 56 includes a first section 56a having a hollow 57 to receive the transformer body 55A, and a-second section 56b disposed on the first section 56a so as to cover up the transformer body 55A.

Referring to FIGS. 6(b), 6(c) and 6(d), the first section 56a includes a bottom 58, side walls 59 vertically disposed at the both sides of the bottom 58, a front end wall 60 vertically disposed at the front end (lower in FIG. 6(a)) of the bottom 58, and a rear end wall 61 (not seen in the figures) vertically disposed at the rear end (upper in FIG. 6(a)) of the bottom 58. A cutout 62 is formed at each of the front end wall 60 and the rear end wall 61, and some portions of the terminal blocks 7 and 8 protrude through respective cutouts 62. That is to say, the external unit 56 is adapted to enclose the transformer body 55A with the terminal blocks 7 and 8 sticking out.

In the inverter transformer 40 according to the fifth embodiment, since the external unit 56 (sintered compact) having a larger saturation magnetic flux density than the magnetic resin 6 is provided so as to enclose the transformer body 55A, most of magnetic flux leaking from the core 3a/3b so as to pass through the magnetic resin 6 and then to leak beyond the magnetic resin 6 is now adapted to pass through the external unit 56. Thus, with provision of the external unit 56, magnetic flux can be prevented from leaking out from the inverter transformer 40 more effectively than when the external unit 56 is not provided. Consequently, the cross section area of the structure according to the fifth embodiment can be reduced compared with the structure in which magnetic flux is prevented from leaking out by means of the magnetic resin 6 only, and the inverter transformer 40 can be downsized.

Since the external unit 56 has a smaller magnetic resistance than the magnetic resin 6, magnetic flux leaking out beyond the magnetic resin 6 passes through the external unit 56 more effectively. Consequently, magnetic flux can be further prevented from leaking out from the inverter transformer 40, which enables further downsizing of the inverter transformer 40.

The inverter transformer 40 according to the fifth embodiment is produced as follows. The winding assembly 51 is put in the hollow 57 of the first section 56a of the external unit 56 with the terminal blocks 7 and 8 fitted in the respective cutouts 62, and a resin material (the magnetic resin 6) is filled in the hollow 57 so as to mold the winding assembly 51. The magnetic resin 6 is heated at, for example, about 150 degrees C for curing, and the transformer body 55A, which is composed of the winding assembly 51 and the magnetic resin 6 filled around the winding assembly 51, is obtained in the hollow 57. Then, the second section 56b of the external unit 56 is put on the first section 56a so as to lid the hollow 57 having the transformer body 55A therein, thus the first section 56a and the second section 56b, in combination, enclose the transformer body 55A, and the inverter transformer 40 is obtained. Since the winding assembly 51 is molded by filling the magnetic resin 6 in the hollow 57, the production is eased enhancing the productivity. In this connection, the second section 56b of the external unit 56 may be omitted so that the external unit 56 is constituted by the first section 56a only.

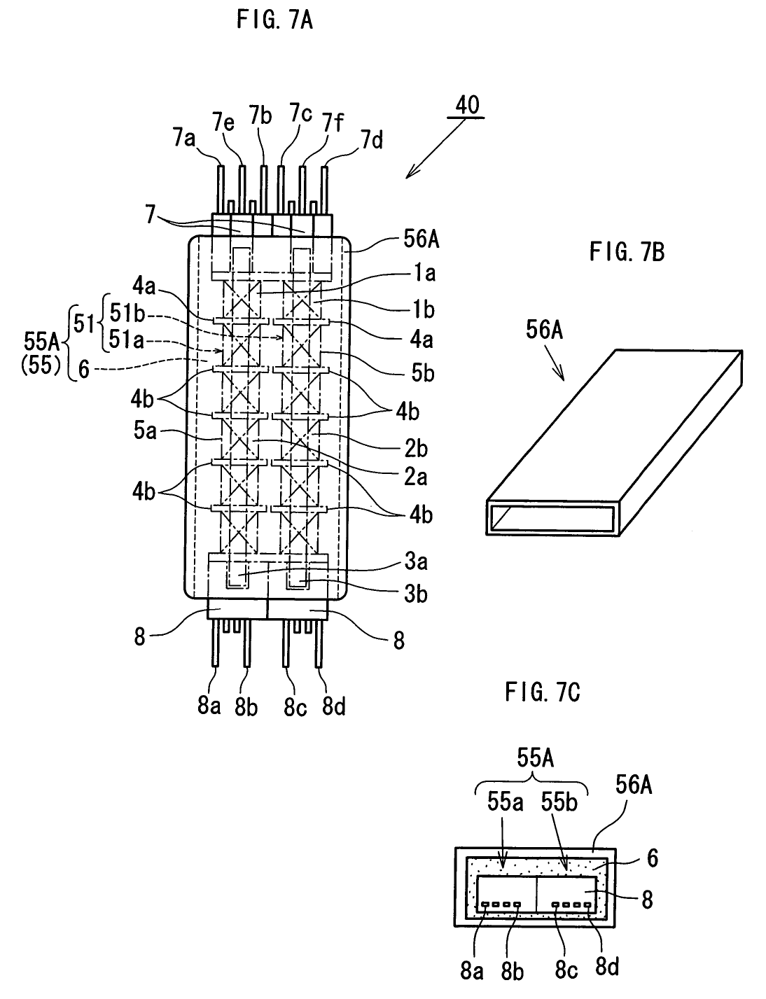

In the fifth embodiment, the external unit 56 is structured so as to cover the top, side, bottom, and front end and rear end (except the terminal blocks 7 and 8) faces of the transformer body 55A, but the present invention is not limited to this structure and arrangement. The transformer body 55B may be used in place of the transformer body 55A, and also the external unit 56 may alternatively be structured as described below with reference to FIGS. 7(a) to 7(c), 8(a) to 8(d), 9(a) to 9(d), 10(a) and 10(b), 11(a) to 11(c), and 12(a) to 12(c).

Referring to FIGS. 7(a), 7(b) and 7(c), an inverter transformer 40 according to a sixth embodiment includes an external unit 56A which is shaped into a rectangular tube so as to cover the top, side, and bottom faces of a transformer body 55A. The external unit 56A has a larger saturation magnetic flux density and a smaller magnetic resistance than a magnetic resin 6.

In the sixth embodiment, the external unit 56A does not cover the front end and rear end faces of the transformer body 55A but still covers most area of the outer surface thereof, and magnetic flux leaking out from the inverter transformer 40 can be duly reduced, and also the inverter transformer 40 can be downsized. And, since the external unit 56A has a smaller magnetic resistance than the magnetic resin 6, magnetic flux can be further prevented from leaking out from the inverter transformer 40, which enables further downsizing of the inverter transformer 40.

Referring to FIGS. 8(a), 8(b) and 8(c), an inverter transformer 40 according to a seventh embodiment includes an external unit 56B which is composed of a roof 63 and two side walls 64 vertically disposed at the both sides of the roof 63 so as to have a squared C shape in cross section, and which covers the top and side faces of a transformer body 55B. The external unit 56B has a larger saturation magnetic flux density and a smaller magnetic resistance than a magnetic resin 6.

In the seventh embodiment, the external unit 56B does not cover the bottom face of the transformer body 55B compared with the external unit 56A in the sixth embodiment described above but still covers a substantial area of the outer surface thereof, and magnetic flux leaking out from the inverter transformer 40 can be duly reduced, and also the inverter transformer 40 can be downsized. And, since the external unit 56B has a smaller magnetic resistance than the magnetic resin 6, magnetic flux can be further prevented from leaking out from the inverter transformer 40, which enables further downsizing of the inverter transformer 40.

In the seventh embodiment described above, the roof 63 of the external unit 56B is defined flat in accordance with the configuration of the transformer body 55B but may alternatively be, for example, arced when the transformer body 55B has an arced configuration. Also, a transformer body 55A may be used in the seventh embodiment in place of the transformer body 55B as shown in FIG. 8(d).

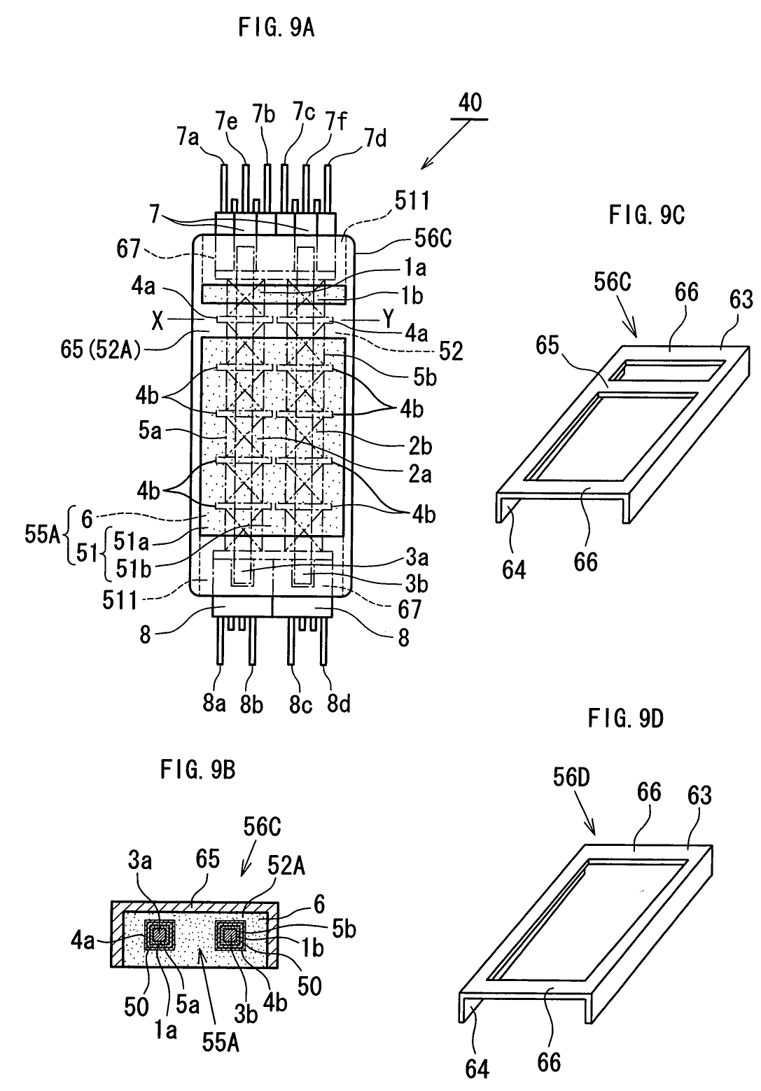

Referring to FIGS. 9(a), 9(b) and 9(c), an inverter transformer 40 according to an eighth embodiment includes an external unit 56C which is composed of a roof 63 and two side walls 64. The roof 63 is divided into a bridge portion 65 sandwiched between two openings and adapted to cover a partition portion 52A (including a partition portion 52 of a winding assembly 51) of a transformer body 55A provided with a partition 4a, two end frame portions 66 adapted to cover both end portions 67 of the transformer body 55A, and two side frame portions (not reference-numbered) perpendicularly adjacent to the side walls 64. The external unit 56C has a larger saturation magnetic flux density than a magnetic rein 6.

Leakage flux is generated abundantly at the partition portion 52 of the winding assembly 51 as described above, but since the partition portion 52A including the partition portion 52 is covered by the bridge portion 65 of the external unit 56C and other portions thereof adjacent to the bridge portion 65, most of magnetic flux leaking out via the partition portion 52A is adapted to pass through the external unit 56C, and therefore leakage flux from the inverter transformer 40 can be well reduced. Also, since the end frame portions 66 of the roof 63 cover respective end portions 67 of the transformer body 55A, leakage flux from the inverter transformer 40 can be further reduced.

In a ninth embodiment shown in FIGS. 9(d) and 9(e), an external unit 56D differs from the external unit 56C of the eighth embodiment in that the bridge portion 65 is eliminated so as to form one opening in a roof 63 as shown in FIG. 9(e).

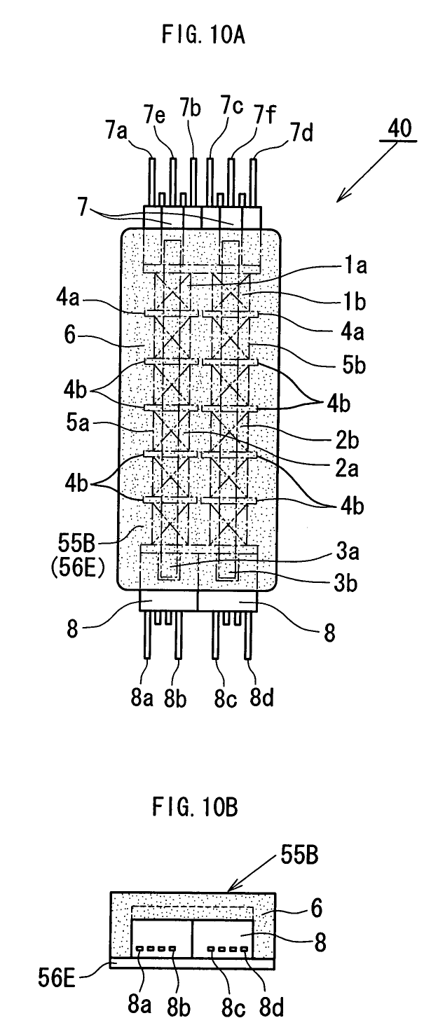

Referring to FIGS. 10(a) and 10(b), an inverter transformer 40 according to a tenth embodiment includes an external unit 56E which is composed of a plate having a rectangular configuration in plan view. The external unit 56E is disposed under a transformer body 55B so as to cover the bottom face of the transformer body 55B. The external unit 56E has a larger saturation magnetic flux density than a magnetic resin 6. In the tenth embodiment, a transformer body 55A may be used in place of the transformer body 55B.

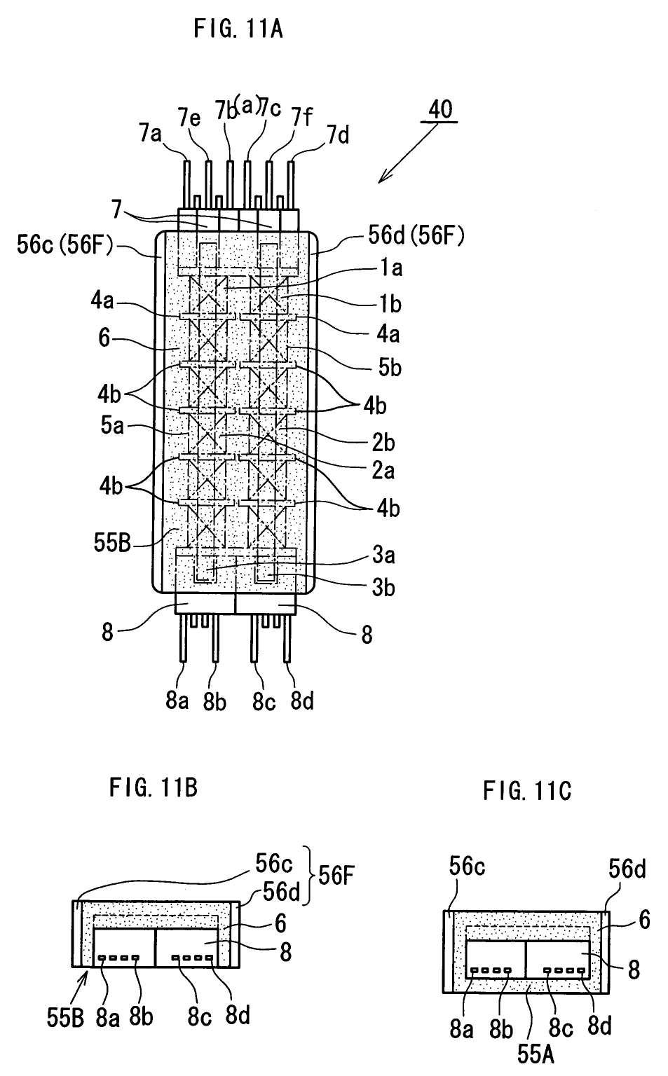

Referring to FIGS. 11(a) and 11(b), an inverter transformer 40 according to an eleventh embodiment includes an external unit 56F which is composed of first and second rectangular plates 56c and 56d. The first and second plates 56c and 56d are disposed respectively at both sides of a transformer body 55B so as to cover the side faces of the transformer body 55B. The external unit 56F has a larger saturation magnetic flux density than a magnetic resin 6. In the eleventh embodiment, a transformer body 55A may be used in place of the transformer 55B as shown in FIG. 11(c).

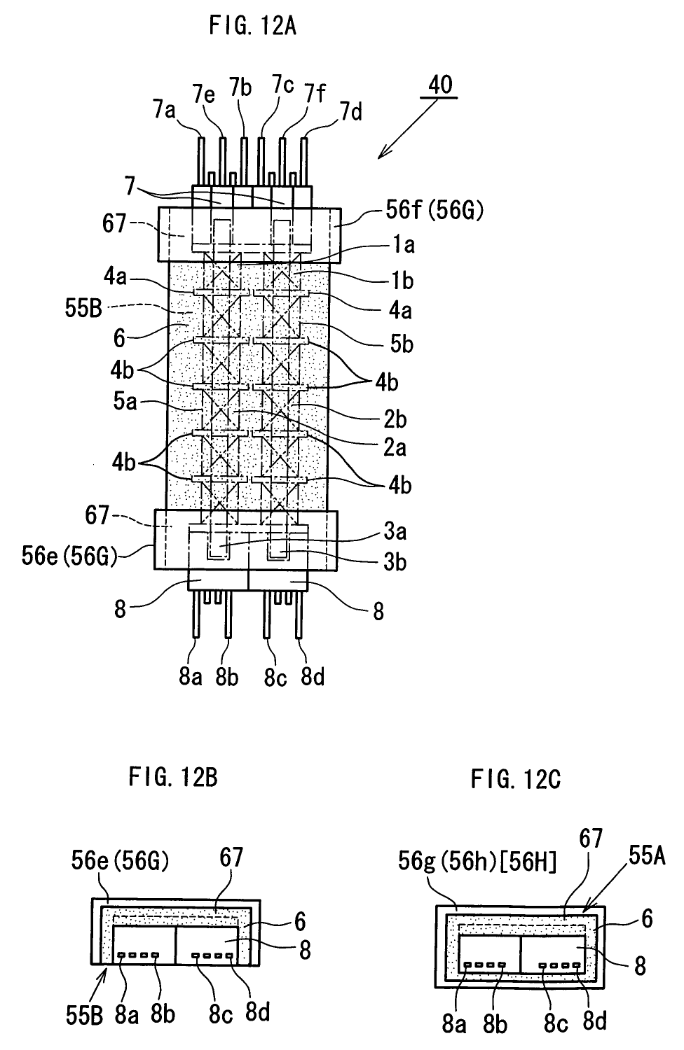

Referring to FIGS. 12(a) and 12(b), an inverter transformer 40 according to a twelfth embodiment includes an external unit 56G which is composed of first and second members 56e and 56f each formed in a structure having a squared C shape in cross section. The first and second members 56e and 56f are disposed respectively at both end portions 67 of a transformer body 55B so as to cover the top and side faces of respective end portions 67. The external unit 56G has a larger saturation magnetic flux density than a magnetic resin 6. In the twelfth embodiment, a transformer body 55A may be used in place of the transformer body 55B.

Referring to FIG. 12(c), an external unit 56H in a thirteenth embodiment is composed of first and second members 56g and 56h each formed in a structure constituting a rectangular frame configuration in cross section. The first and second members 56g and 56h are disposed respectively at both end portions 67 of a transformer body 55A so as to cover the top, side, and bottom faces of respective end portions 67. The external unit 56H has a larger saturation magnetic flux density than a magnetic resin 6. In the thirteenth embodiment, a transformer body 55B may be used in place of the transformer body 55A.

In the above-described embodiments shown in FIGS. 6(a) to 6(d), and FIGS. 9(a) to 9(d) through FIGS. 11(a) to 11(c), an inverter transformer includes either a transformer body 55A (where a magnetic resin 6 covers all faces of a winding assembly 51) or a transformer body 55B (where a magnetic resin 6 covers the top and side faces only of a winding assembly 51), but the present invention is not limited to this transformer body arrangement, and any different type transformer bodies may be used in combination with an external unit 56 or any one of its modifications.

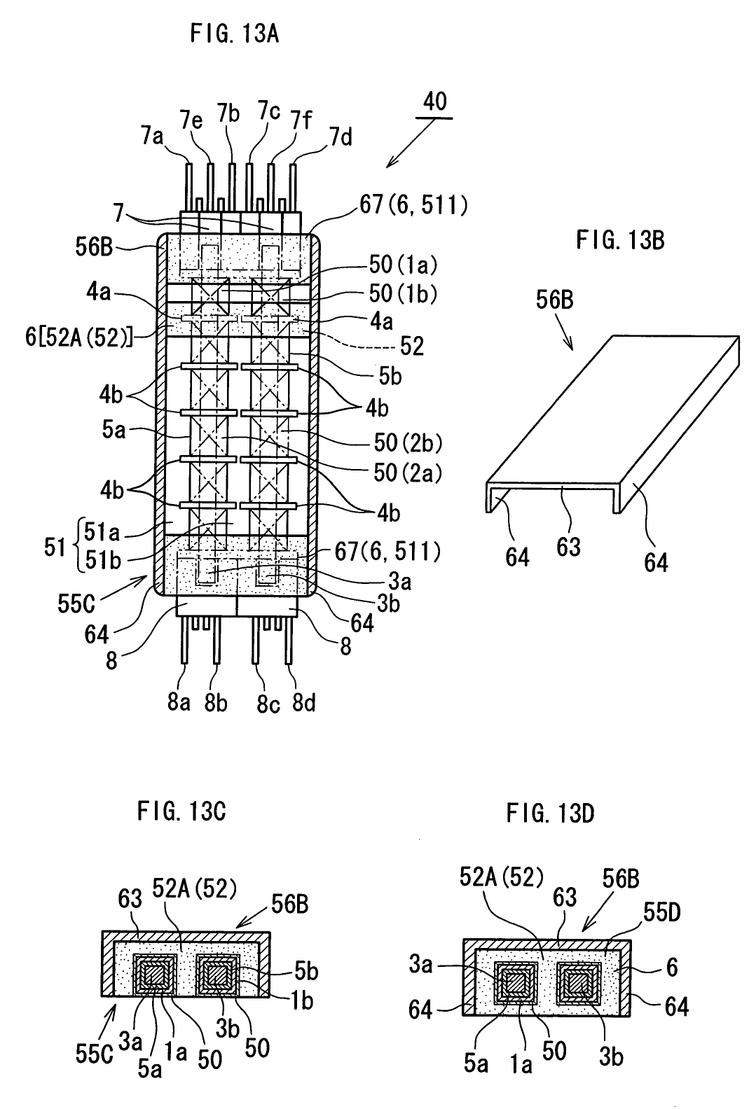

For example, referring to FIGS. 13(a) and 13(c), a transformer body 55C, in which a magnetic resin 6 is composed of three pieces adapted to cover respectively both end portions 511, 511 and a partition portion 52 of a winding assembly 51 at the top and side faces thereof, is used in combination with an external unit 56B shown in FIG. 13(b) (a fourteenth embodiment). Also, referring to FIG. 13(d), a transformer body 55D, in which a magnetic resin 6 is composed of three pieces adapted to cover respectively both end portions 511, 511 and a partition portion 52 of a winding assembly 51 at the top, side and bottom faces, is used in combination with an external unit 56B (a fifteenth embodiment).

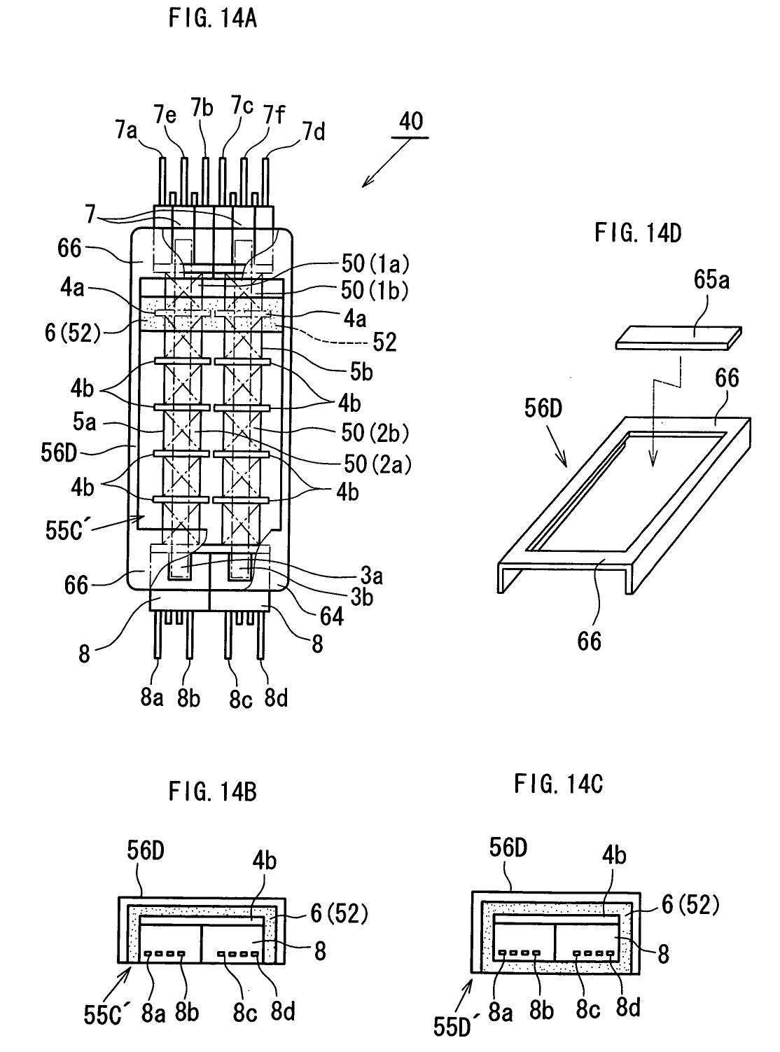

Further, referring to FIGS. 14(a) and 14(b), a transformer body 55C′, in which a magnetic resin 6 covers the top and side faces of a partition portion 52 of a winding assembly 51, is used in combination with an external unit 56D shown in FIG. 14(d) (a sixteenth embodiment). Also, referring to FIG. 14(c), a transformer body 55D′, in which a magnetic resin 6 covers the top, side, and bottom faces of a partition portion 52 of a winding assembly 51, is be used in combination with an external unit 56D (a seventeenth embodiment). The sixteenth and seventeenth embodiments may alternatively be structured such that an external unit 56D is put on a winding assembly 51 eliminating a magnetic resin 6, and a plate member 65a shown in FIG. 14(d) is disposed so as to cover the top face of a partition portion 52. The plate member 65a is formed of a material equivalent to that of the external unit 56D or the magnetic resin 6.

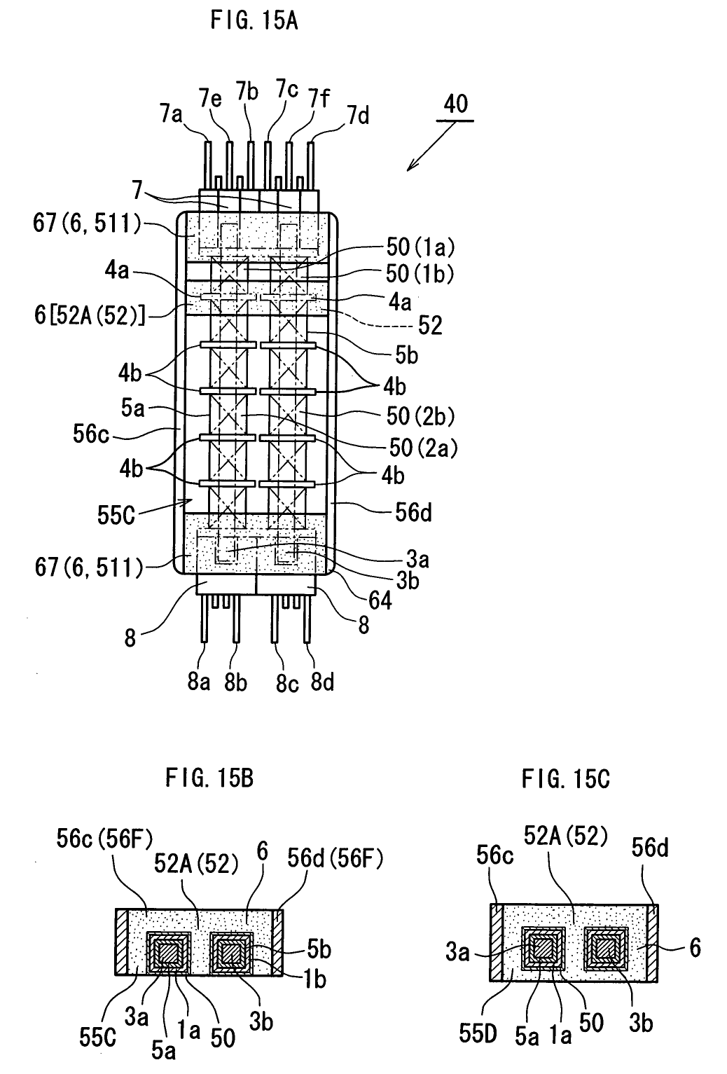

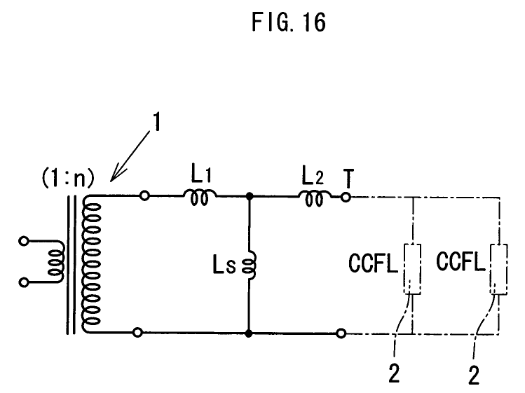

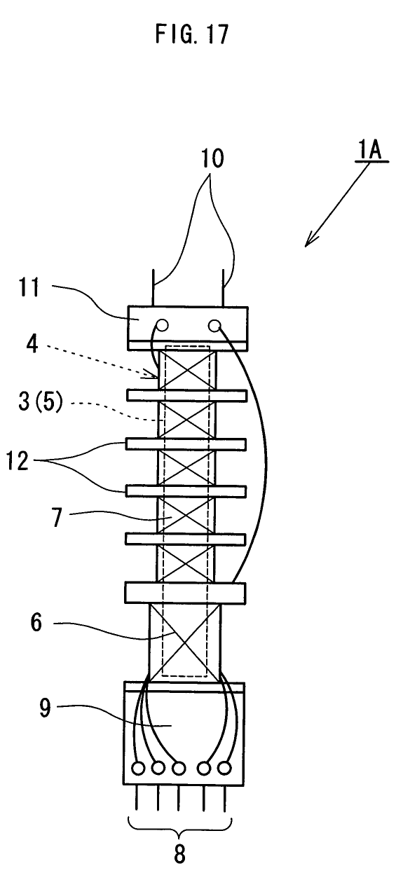

And, referring to FIGS. 15(a) and 15(b), an external unit 56F composed of first and second rectangular plates 56c and 56d is used in combination with a transformer body 55C (an eighteenth embodiment). Also, referring to FIG. 15(c), an external unit 56F composed of first and second rectangular plates 56c and 56d is used in combination with a transformer body 55D (a nineteenth embodiment).

### EXAMPLE

The inverter transformer 40 according to the second embodiment described above will hereinafter be explained as an example. In the inverter transformer 40 as an example: the cores 3a and 3b are formed of Mn—Zn ferrite having a relative magnetic permeability of 2000 and have a height of 3 mm, a width of 3 mm, and a length of 30 mm; the magnetic resin 6 is made such that Mn—Zn ferrite powder having a relative magnetic permeability of about 2000 is mixed with a thermosetting epoxy resin in a volume ratio of 80%; the terminal blocks 7 and 8 are formed of an insulating material and have a height of 6 mm; the bobbins 5a and 5b have a height of 3 mm; the insulating partitions 4b between each section have a height of 2 mm; and the primary windings 1a and 1b and the secondary windings 2a and 2b are wound around the bobbins 5a and 5b and have a winding thickness of about 0.5 mm.

In the example of the inverter transformer 40 as described above, the magnetic resin 6 was arranged as shown in FIG. 1(c), specifically such that the top, side, and bottom faces of the structure, which is constituted by the cores 3a and 3b, the bobbins 5a and 5b, the primary windings 1a and 1b, and the secondary windings 2a and 2b, were covered by the magnetic resin 6 from one ends of the cores 3a and 3b to the other ends thereof. The magnetic resin 6 was dimensioned to have a thickness measuring about 3 mm beyond the perimeters of the partitions 4b, and was cured at about 150 degrees C.

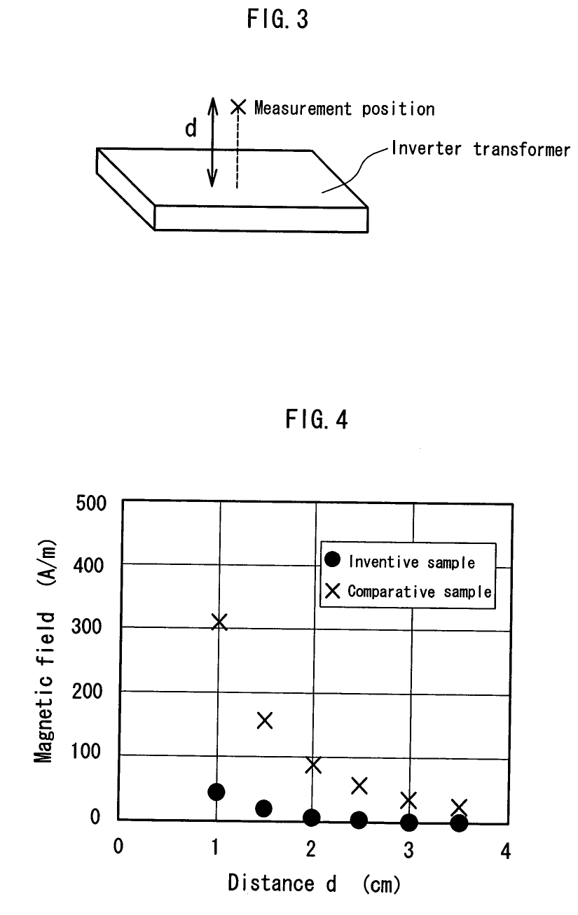

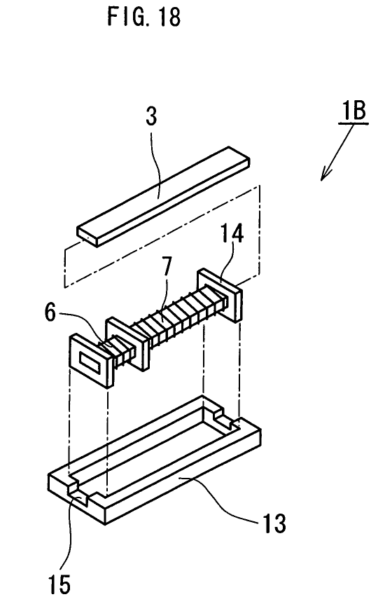

CCFLs were lighted using the inverter transformer 40 described above, and the intensity of surrounding magnetic field due to leakage flux coming out from the inverter transformer 40B was measured. The measurement results are shown in FIG. 4. Also shown in FIG. 4 are measurement results gained on the conventional inverter transformer 1A shown in FIG. 18 which is not provided with a magnetic resin 6. Referring to FIG. 3, d indicates a distance from the top face of the middle of the winding of the inverter transformer to the measurement point. In FIG. 4, the horizontal axis indicates the distance d, and the vertical axis indicates the intensity of magnetic field measured at the distance d.

As shown in FIG. 4, the intensity of magnetic field decreases with an increase of the distance d. More specifically, the intensity of magnetic field is inversely proportional approximately to the square of the distance d. FIG. 4 shows that the intensity of the magnetic field on the inverter transformer 40 of the present invention is smaller than the intensity of the magnetic field on the conventional inverter transformer 1A shown in FIG. 18. For example, if you look at the distance d of 2 cm, the intensity of the magnetic field on the inverter transformer 40 is 8.1 A/m, while the intensity of the magnetic field on the conventional inverter transformer 1A is 89 A/m. Thus, the present invention significantly reduces the intensity of surrounding magnetic field attributable to leakage flux from an inverter transformer.

### INDUSTRIAL APPLICABILITY

An inverter transformer with an open magnetic path structure can be provided, whose entire structure and production process are simplified thus preventing cost increase.

1. An inverter transformer which is provided in an inverter circuit to invert DC into AC, and which transforms a voltage inputted at a primary side and outputs the transformed voltage at a secondary side, the inverter transformer comprising:
at least one winding unit comprising a bar-shaped magnetic core, and a primary winding and a secondary winding wound around the bar-shaped magnetic core; and
a magnetic resin formed of a resin containing a magnetic substance, the magnetic resin covering at least one portion of the winding unit with respect to a core length direction so that the primary and the secondary windings have respective predetermined leakage inductances.

2. An inverter transformer according to claim 1, wherein the magnetic resin covers an entire portion of the winding unit with respect to the core length direction.

3. An inverter transformer according to claim 1, wherein the magnetic resin covers, with respect to the core length direction, at least one of: both end portions of the winding unit; and a portion of the winding unit located at a boundary area between the primary and secondary windings.

4. An inverter transformer according to claim 1, wherein an external unit having a larger saturation magnetic flux density than the magnetic resin is disposed so as to cover at least one portion of a circumference of a transformer body which comprises the at least one winding unit and the magnetic resin.

5. An inverter transformer according to claim 4, wherein the external unit has a smaller magnetic resistance than the magnetic resin.

6. An inverter transformer according to claim 4, wherein the external unit has one of a squared C configuration and a substantially circular configuration in cross section so as to cover the circumference of the transformer body.

7. An inverter transformer according to claim 4, wherein the external unit comprises a plurality of members, and the members are combined into a box configuration so as to cover the transformer body.

8. An inverter transformer according to claim 1, wherein the external unit is made of a sintered material.

9. An inverter transformer according to claim 1, wherein the magnetic resin has a smaller relative magnetic permeability than the bar-shaped magnetic core.

10. An inverter transformer according to claim 1, wherein the magnetic substance contained in the resin is one of Mn—Zn ferrite, Ni—Zn ferrite, and iron powder.
